(19) United States
(12) Patent Application Publication
(10) Pub. No.: US 2017/0275482 A1
(43) Pub. Date: Sep. 28, 2017

(54) AQUEOUS INK COMPOSITION FOR DECORATIVE SHEET, PRINTED ITEM, AND LAMINATE FOR DECORATIVE SHEET

(71) Applicants: TOYO INK SC HOLDINGS CO., LTD., Tokyo (JP); TOYO INK CO., LTD., Tokyo (JP)

(72) Inventors: Taketo KOGURE, Tokyo (JP); Takashi HANAZONO, Tokyo (JP); Tomohiko OKA, Tokyo (JP); Katsuyuki UEKI, Tokyo (JP)

(73) Assignees: TOYO INK SC HOLDINGS CO., LTD., Tokyo (JP); TOYO INK CO., LTD., Tokyo (JP)

(21) Appl. No.: 15/466,869

(22) Filed: Mar. 23, 2017

(30) Foreign Application Priority Data
Mar. 24, 2016 (JP) 2016-060205

(51) Int. Cl. C09D 11/107; B41M 5/00; C09D 11/037

(52) U.S. Cl. CPC C09D 11/107; C09D 11/037; B41M 5/0023

(57) ABSTRACT

An aqueous ink composition for a decorative sheet which can be printed without any disturbance of the printed portion caused by friction with the guide rollers or the like during printing, and also exhibits good permeability following immersion in an adhesive (impregnating solution) during post processing, and good adhesion to substrates following thermocompression bonding. Specifically, an aqueous ink composition for use on a base paper for a decorative sheet, the aqueous ink composition comprising a pigment and a water-soluble polyacrylamide resin (A).

### CROSS-REFERENCE TO RELATED APPLICATION

This application claims the priority benefit of Japan application no. 2016-060205, filed on Mar. 24, 2016. The entirety of the above-mentioned patent applications is hereby incorporated by reference herein and made a part of this specification.

### TECHNICAL FIELD

The present invention relates to an aqueous ink composition for use on a decorative base paper, and also relates to a printed item and a laminate for a decorative sheet that use the aqueous ink composition.

### BACKGROUND ART

Base materials for decorative sheets include paper-based base materials called decorative base papers. Titanium paper is a representative example of this type of decorative base paper. Titanium paper is prepared by incorporating titanium oxide in a paper to impart the paper with superior opacity. Although colored decorative base papers also exist, most decorative base papers are usually printed with a pattern such as woodgrain or marble grain using a printing ink. These printed items are impregnated with a melamine resin or polyester resin solution, and then bonded to a substrate by hot press molding to form a decorative sheet. These types of decorative sheets are used in all manner of applications, including system kitchens, household and office furniture, commercial facilities, and interior finishings in trains and the like.

However, when a printed item obtained by using any of the various available printing inks to print a pattern onto a base paper such as titanium paper is impregnated with a melamine resin or the like and then bonded to a substrate, if the printing ink does not permeate into the base paper, then the adhesion between the ink layer and the melamine resin tends to be poor, causing problems such as delamination or susceptibility to peeling.

Methods for resolving these problems by applying a primer to the printing surface of the base paper have been proposed, but not only does this require additional equipment such as a primer coating device and drying device, but the production process also becomes more complex, resulting in increased product costs.

Other older documents have described examples in which casein resin is used as the binder resin for the aqueous ink, but casein systems tend to suffer from thermal contraction and wrinkling during the drying performed following impregnation, and tend to be prone to delamination following the subsequent thermal lamination process (JP H05-208547 A). Examples in which an aqueous resin such as an acrylic resin and a urethane resin emulsion are used in combination with the casein resin in order to ameliorate thermal contraction have also been reported, and although this combination of a plurality of resins improves the thermal contraction, cissing and air bubbles are not able to be completely prevented during the impregnation (JP 2005-88220 A). Further, other examples in which an unsaturated polyester and a curing accelerator are included in the ink composition to address the above problems have also been disclosed (JP S59-211700 A), but these examples are unable to fully resolve the problems.

Accordingly, current aqueous inks designed for decorative base papers are not capable of providing all of the required performance properties.

### SUMMARY OF THE INVENTION

The present invention provides an aqueous ink composition for a decorative sheet which can be printed without any disturbance of the printed portion caused by friction with the guide rollers or the like during printing, and also exhibits good permeability following immersion in an adhesive (impregnating solution) during post processing, and good adhesion to substrates following thermocompression bonding.

As a result of intensive research aimed at addressing the various problems described above, the inventors of the present invention discovered that an aqueous ink composition described below was able to resolve the problems, enabling them to complete the present invention.

One aspect of the present invention provides an aqueous ink composition for use on a base paper for a decorative sheet, the aqueous ink composition comprising:

a pigment, and

a water-soluble polyacrylamide resin (A).

In one aspect of the present invention,

the proportion of structural units derived from acrylamide within 100% by weight of the polyacrylamide resin (A) may be 70% by weight or greater.

In one aspect of the present invention,

the glass transition temperature of the polyacrylamide resin (A) may be within a range from 80° C. to 200° C.

Another aspect of the present invention provides the aqueous ink composition described above, which further comprises:

a water-soluble resin (B), wherein

the water-soluble resin (B) has a solid fraction acid value prior to neutralization of 50 to 350 mgKOH/g and a glass transition temperature within a range from 50° C. to 140° C., and is a different resin from the polyacrylamide resin (A).

Yet another aspect of the present invention provides the aqueous ink composition described above, which further comprises:

an emulsion resin (C), wherein

the emulsion resin (C) has a minimum film-forming temperature (MFT) of 40° C. or lower.

Yet another aspect of the present invention provides the aqueous ink composition described above, which further comprises:

a water-soluble resin (B) and an emulsion resin (C), wherein

the water-soluble resin (B) has a solid fraction acid value prior to neutralization of 50 to 350 mgKOH/g and a glass transition temperature within a range from 50° C. to 140° C., and is a different resin from the polyacrylamide resin (A), and

the emulsion resin (C) has a minimum film-forming temperature (MFT) of 40° C. or lower.

In one aspect of the present invention,

the water-soluble resin (B) may be at least one resin selected from the group consisting of acrylic resins (b1) and styrene-acidic monomer copolymer resins (b2).

In one aspect of the present invention,

the emulsion resin (C) may be at least one resin selected from the group consisting of acrylic resins (c1), styrene-acrylic copolymer resins (c2), and urethane resins (c3).

In one aspect of the present invention,

the amount of the water-soluble resin (B) may be within a range from 0.1% by weight to 40% by weight relative to 100% by weight of the polyacrylamide resin (A).

In one aspect of the present invention,

the amount of the emulsion resin (C) may be within a range from 0.1% by weight to 40% by weight relative to 100% by weight of the polyacrylamide resin (A).

Yet another aspect of the present invention provides a printed item comprising:

a base paper for a decorative sheet, and

a printed layer formed on the base paper for a decorative sheet, wherein the printed layer is formed from the aqueous ink composition described above.

Yet another aspect of the present invention provides a laminate for a decorative sheet comprising:

a substrate and a surface layer, wherein

the surface layer is formed from a thermosetting compound and the printed item described above.

### EMBODIMENTS OF THE INVENTION

Embodiments of the present invention are described below in detail, but the following description of structural elements merely presents examples (representative examples) of embodiments of the present invention, and the scope of the present invention is in no way limited by the content of the embodiments described below.

The aqueous ink composition of the present invention is an aqueous ink composition for use on a base paper for a decorative sheet, the aqueous ink composition comprising a pigment and a water-soluble polyacrylamide resin (A).

In this description, the glass transition temperature (hereafter sometimes referred to as “Tg”) is obtained as a calculated value using the following FOX equation.

FOX equation: 1/Tg=W1/Tg1+W2/Tg2+ . . . +Wi/Tgi+ . . . +Wn/Tgn

In the above FOX equation, the glass transition temperature of a homopolymer of each monomer that constitutes a polymer formed from n different monomers is termed Tgi (K), and the mass fraction of each monomer is termed Wi, wherein (W1+W2+ . . . +Wi+ . . . +Wn=1).

Further, the weight-average molecular weight indicates the polystyrene-equivalent value determined by GPC measurement. The acid value is the number of mg of potassium hydroxide required to neutralize the carboxyl groups contained within 1 g of the resin solid fraction, and is a value measured in accordance with JIS K0070.

In this description, the minimum film-forming temperature (MFT) is a value obtained, in accordance with the method of JIS K 6828-2, by applying the composition to a glass plate using a 300 μm applicator, and then measuring the resulting sample with a thermal gradient test device (manufactured by Rigaku Corporation).

### <Polyacrylamide Resin (A)>

A water-soluble polyacrylamide resin (A) is used in the aqueous ink composition of the present invention. The water-soluble polyacrylamide resin (A) exhibits good affinity with decorative base papers, and by using the polyacrylamide resin (A) as a binder resin, an ink with good permeability into the decorative base paper can be obtained. Among the various types of base paper, titanium paper is particularly preferred, as the hydroxyl groups within the cellulose and the titanium oxide form hydrogen bonds with the amide structures in the polyacrylamide resin (A). Further, in the step of impregnating the printed item with a thermosetting resin solution of a melamine resin or the like, the impregnating solution is able to permeate uniformly into the printed portion, and in the step of performing thermocompression bonding to another substrate following drying, uniform bonding can be achieved, meaning a laminate having favorable external appearance and no delamination can be obtained.

In the polyacrylamide resin (A), the proportion of structural units derived from acrylamide is preferably as high as possible. Of the 100% by weight of the polyacrylamide resin (A), the proportion of structural units derived from acrylamide is preferably at least 70%, more preferably at least 85%, and most preferably 90% or greater.

The glass transition temperature (Tg) of the polyacrylamide resin (A) is preferably within a range from 80° C. to 200° C., and can be adjusted as desired by copolymerization with other acrylic monomers. The Tg of the polyacrylamide resin (A) is more preferably within a range from 100° C. to 180° C., and even more preferably from 105° C. to 175° C.

In the following description, the terms (meth)acrylic and (meth)acrylate mean methacrylic and acrylic, and methacrylate and acrylate respectively.

The polyacrylamide resin (A) may comprise other acrylic monomers or styrene-based monomers or the like besides the acrylamide monomer, provided the affinity of the resulting resin with the decorative base paper is not impaired, and of these other monomers, acrylic monomers other than the acrylamide monomer are preferred.

Examples of these other acrylic monomers include, but not limited to, methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, isooctyl (meth)acrylate, decyl (meth)acrylate, dodecyl (meth)acrylate, tetradecyl (meth)acrylate, hexadecyl (meth)acrylate and octadecyl (meth)acrylate. Among these monomers, butyl (meth)acrylate is preferred in terms of producing superior adhesion to polyester substrates. These monomers may be used individually, or combinations of two or more monomers may be used.

Further, the aforementioned acrylic monomer may have a hydroxyl group, and examples of such monomers include, but not limited to, hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth) acrylate, 6-hydroxyhexyl (meth)acrylate and 8-hydroxyoctyl (meth)acrylate, glycol mono(meth)acrylates such as polyethylene glycol mono(meth)acrylate, polypropylene glycol mono(meth)acrylate and 1,4-cyclohexanedimethanol mono(meth)acrylate, as well as caprolactone-modified (meth)acrylates and hydroxyethylacrylamide. Among these monomers, 2-hydroxyethyl (meth)acrylate and 4-hydroxybutyl (meth)acrylate are particularly preferred, as they improve the solubility in water. These monomers may be used individually, or combinations of two or more monomers may be used.

The aforementioned acrylic monomer may have a functional group other than a hydroxyl group, and examples of this functional group include a carboxyl group, amide linking group, amino group, alkylene oxide group, and a benzene ring structure.

Examples of carboxyl group-containing acrylic monomers, which are compounds of the aforementioned acrylic monomers having a carboxyl group, include, but not limited to, (meth)acrylic acid, phthalic acid monohydroxyethyl acrylate, p-carboxybenzyl acrylate, ethylene oxide-modified (number of added moles: 2 to 18) phthalic acid acrylate, phthalic acid monohydroxypropyl acrylate, succinic acid monohydroxyethyl acrylate, β-carboxyethyl acrylate, 2-(4-benzoyl-3-hydroxyphenoxy)ethyl acrylate, maleic acid, maleic anhydride, monoethylmaleic acid, itaconic acid, citraconic acid and fumaric acid.

Further, examples of amide linking group-containing acrylic monomers, which are compounds of the aforementioned acrylic monomers having an amide linking group, include, but not limited to, compounds such as N-isopropyl (meth)acrylamide and N,N-diethylacrylamide.

Further, examples of amino group-containing acrylic monomers, which are compounds of the aforementioned acrylic monomers having an amino group, include, but not limited to, monoalkylaminoalkyl esters of (meth)acrylic acid such as monomethylaminoethyl (meth)acrylate, monoethylaminoethyl (meth)acrylate, monomethylaminopropyl (meth)acrylate and monoethylaminopropyl (meth)acrylate.

Further, examples of alkylene oxide group-containing acrylic monomers, which are compounds of the aforementioned acrylic monomers having an alkylene oxide unit, include, but not limited to, 2-methoxyethyl acrylate, 2-ethoxyethyl acrylate, 2-phenoxyethyl acrylate, methoxy polyethylene glycol (meth)acrylate, ethoxy polyethylene glycol (meth)acrylate, methoxy polypropylene glycol (meth)acrylate, ethoxy polypropylene glycol (meth)acrylate, phenoxy polyethylene glycol (meth)acrylate and phenoxy polypropylene glycol (meth)acrylate.

Furthermore, examples of benzene ring structure-containing acrylic monomers, which are compounds of the aforementioned acrylic monomers having a benzene ring structure, include, but not limited to, phenyl (meth)acrylate, benzyl (meth)acrylate, phenoxymethyl (meth)acrylate, phenoxyethyl (meth)acrylate and 2-hydroxy-3-phenoxypropyl (meth)acrylate.

A chain transfer agent may be used during synthesis of the polyacrylamide resin (A), and the amount of the chain transfer agent is preferably from 0.01 to 2.0% by weight relative to 100% by weight of the total weight of monomers. Examples of the chain transfer agent include, but not limited to, alkylmercaptans, thioglycolic acid and esters thereof, isopropyl alcohol, and monomers having an allyl group such as allyl alcohol, allylamine and (meth)allyl sulfonic acid. Of these chain transfer agents, (meth)allyl sulfonic acid, and alkali metal salts such as the sodium salt and potassium salt, or the ammonium salt, of (meth)allyl sulfonic acid are preferred.

Further, a crosslinking agent may be used during synthesis of the polyacrylamide resin (A), and the amount of the crosslinking agent is preferably from 0.01 to 2.0% by weight relative to 100% by weight of the total weight of monomers. Examples of the crosslinking agent include, but not limited to, polyfunctional monomers such as N-substituted (meth)acrylamides, di(meth)acrylates, bis(meth)acrylamides, and difunctional to tetrafunctional vinyl monomers such as divinyl esters. These crosslinking agents may be used individually, or combinations of two or more crosslinking agents may be used. Other examples of crosslinking agents that may be used in the present invention include water-soluble aziridinyl compounds, water-soluble polyfunctional epoxy compounds, and silicon-based compounds. Of the above crosslinking agents, N-substituted (meth)acrylamides are preferred. These may be used individually, or in combinations of two or more compounds.

Specific examples of the above N-substituted (meth)acrylamides include, but not limited to, N-methyl (meth)acrylamide, N-ethyl (meth)acrylamide, N,N-dimethyl (meth)acrylamide, N,N-diethyl (meth)acrylamide, N-isopropyl (meth)acrylamide and N-t-octyl (meth)acrylamide.

Specific examples of the above di(meth)acrylates include, but not limited to, ethylene glycol di(meth)acrylate, diethylene glycol di(meth)acrylate, triethylene glycol di(meth)acrylate, polypropylene glycol di(meth)acrylate and glycerol di(meth)acrylate. These compounds may be used individually, or combinations of two or more compounds may be used.

Specific examples of the above bis(meth)acrylamides include, but not limited to, N,N′-methylenebis(meth)acrylamide, ethylenebis(meth)acrylamide, hexamethylenebis(meth)acrylamide, N,N′-bis(acrylamido)acetic acid, methyl N,N′-bis(acrylamido)acetate, N,N-benzylidenebisacrylamide and N,N′-bis(acrylamidomethylene)urea. These compounds may be used individually, or combinations of two or more compounds may be used.

Specific examples of the above divinyl esters include, but not limited to, divinyl adipate, divinyl sebacate, diallyl phthalate, diallyl maleate and diallyl succinate. These compounds may be used individually, or combinations of two or more compounds may be used.

Various polyfunctional monomers other than those mentioned above can be used in the present invention, and among these other polyfunctional monomers, specific examples of difunctional monomers include, but not limited to, allyl (meth)acrylate, divinylbenzene, diisopropenylbenzene, N-methylolacrylamide, diallyldimethylammonium salts, diallylamine, diallyl chlorendate, glycidyl (meth)acrylate and silicon-based compounds. These difunctional monomers may be used individually, or combinations of two or more monomers may be used.

Specific examples of trifunctional monomers include, but not limited to, triacrylformal, triallyl isocyanurate, N,N-diallylacrylamide, N,N-diallylmethacrylamide, triallylamine and triallyl trimellitate. These trifunctional monomers may be used individually, or combinations of two or more monomers may be used.

Specific examples of tetrafunctional monomers include, but not limited to, tetramethylolmethane tetraacrylate, tetraallyl pyromellitate, N,N,N′,N′-tetraallyl-1,4-diaminobutane, tetraallylamine salts and tetraallyloxyethane. These tetrafunctional monomers may be used individually, or combinations of two or more monomers may be used.

Examples of the aforementioned water-soluble aziridinyl compounds include, but not limited to, tetramethylolmethane-tri-β-aziridinyl propionate, trimethylolpropane-tri-β-aziridinyl propionate and 4,4′-bis(ethyleneiminecarbonylamino)diphenylmethane. These compounds may be used individually, or combinations of two or more compounds may be used.

Examples of the aforementioned water-soluble polyfunctional epoxy compounds include, but not limited to, (poly)ethylene glycol diglycidyl ether, (poly)propylene glycol diglycidyl ether, (poly)glycerol diglycidyl ether and (poly)glycerol triglycidyl ether. These compounds may be used individually, or combinations of two or more compounds may be used.

Examples of the aforementioned silicon-based compounds include, but not limited to, 3-(meth)acryloxypropyltrimethoxysilane, 3-(meth)acryloxypropyldimethoxymethylsilane, 3-(meth)acryloxypropyltriethoxysilane, 3-(meth)acryloxypropylmethyldichlorosilane, 3-(meth)acryloxyoctadecyltriacetoxysilane, 3-(meth)acryloxy-2,5-dimethylhexyldiacetoxymethylsilane and vinyldimethylacetoxysilane. These compounds may be used individually, or combinations of two or more compounds may be used.

There are no particular limitations on the polymerization initiator used during synthesis of the polyacrylamide resin (A), and known polymerization initiators may be used. Examples include, but not limited to, persulfates such as sodium persulfate, potassium persulfate and ammonium persulfate, peroxides such as hydrogen peroxide, benzoyl peroxide, tert-butyl hydroperoxide and di-tert-butyl peroxide, bromates such as sodium bromate and potassium bromate, perborates such as sodium perborate, potassium perborate and ammonium perborate, percarbonates such as sodium percarbonate, potassium percarbonate and ammonium percarbonate, and perphosphates such as sodium perphosphate, potassium perphosphate and ammonium perphosphate. These polymerization initiators may be used individually, but may also be combined with a reducing agent and used as a redox-type polymerization initiator.

Examples of the reducing agent include, but not limited to, sulfites, hydrogen sulfites, organic amines such as N,N,N′,N′-tetramethylethylenediamine, and reducing sugars such as aldose. Further, azo compounds such as azobisisobutyronitrile, 2,2′-azobis-2-amidinopropane hydrochloride, 2,2′-azobis-2,4-dimethylvaleronitrile and 4,4′-azobis-4-cyanovaleric acid and salts thereof may also be used. These initiators may be used individually, or combinations of two or more initiators may be used.

There are no particular limitations on the method used for producing the polyacrylamide resin (A), and any conventionally known method may be used. For example, the target polyacrylamide resin (A) can be obtained by charging a reactor fitted with a stirrer and a thermometer with the aforementioned monomer(s) and water as a solvent (which may be used in combination with an organic solvent if required) under an atmosphere of an inert gas such as nitrogen, adding a chain transfer agent if required, adjusting the pH as required using a pH modifier composed of an acid such as sulfuric acid or hydrochloric acid or an alkali such as sodium hydroxide, potassium hydroxide or ammonia, subsequently adding a polymerization initiator, and then reacting the mixture at a reaction temperature of 20 to 90° C. for 1 to 5 hours. Further, if necessary the polymerization may also be performed by adding either a portion or all of the monomer, water, chain transfer agent, pH modifier and/or polymerization initiator in a dropwise manner to the reactor.

Although there are no particular limitations on the weight-average molecular weight of the polyacrylamide resin (A), the weight-average molecular weight is preferably within a range from 1,000,000 to 10,000,000, more preferably from 2,000,000 to 7,000,000, and even more preferably from 2,000,000 to 6,000,000.

### <Water-Soluble Resin (B)>

The aqueous ink composition of the present invention may also comprise a water-soluble resin (B). The water-soluble resin (B) has a solid fraction acid value prior to neutralization of 50 to 350 mgKOH/g and a glass transition temperature within a range from 50° C. to 140° C., and is preferably at least one resin (different from the resin (A)) selected from the group consisting of acrylic resins (b1) and styrene-acidic monomer copolymer resins (b2). Among such resins, styrene-acrylic acid copolymer resins and styrene-maleic acid copolymer resins are particularly preferred.

Even when the ink composition comprises only the polyacrylamide resin (A), the various physical properties of the composition and the permeability of the composition into decorative base papers are favorable, but by also including the water-soluble resin (B), the abrasion resistance of the ink layer can be improved. For example, in those cases where excessive friction occurs between the printed surface and the guide rollers during printing, including the water-soluble resin (B) can prevent disturbance of the printed surface. The solid fraction acid value of the water-soluble resin (B) prior to neutralization is preferably within a range from 50 to 350 mgKOH/g, more preferably from 100 to 350 mgKOH/g, and even more preferably from 100 to 250 mgKOH/g. Further, it is preferable that some or all of the acid value is neutralized by an amine compound (c) described below.

Further, the glass transition temperature of the water-soluble resin (B) is preferably within a range from 50° C. to 140° C., and more preferably from 60° C. to 135° C. Moreover, a resin having a glass transition temperature of 80° C. to 120° C. may also be used as the water-soluble resin (B). Ensuring that the glass transition temperature of the water-soluble resin (B) is within a range from 50° C. to 140° C. makes the printed portion tougher, meaning good abrasion resistance between the printed portion and the guide rollers during printing (hereafter sometimes referred to as “dry rubbing resistance”) can be obtained, and disturbance of the printed portion caused by friction with the rollers when removing the printed item from the impregnation step performed after printing can also be prevented (hereafter sometimes referred to as “wet rubbing resistance”).

Examples of the amine compound (c) include, but not limited to, ammonia and organic amines such as monoethylamine, diethylamine, trimethylamine, triethylamine, triisopropylamine, tributylamine, triethanolamine, methyldiethanolamine, monoethanolamine, dimethylethanolamine, diethylethanolamine, morpholine, N-methylmorpholine and 2-amino-2-methyl-1-propanol. These amine compounds (c) may be used individually, or combinations of two or more compounds may be used. In terms of the film strength following printing and the “dry rubbing resistance,” the amine compound (c) is preferably water-soluble and easily volatilized by heating, and ammonia is particularly desirable. These amine compounds (c) used for neutralization can volatilize following printing and drying, imparting water resistance to the printed item. The pH of the aqueous solution of the water-soluble resin (B) is preferably from 7 to 9.

In the aqueous ink composition of the present invention, the amount of the solid fraction of the water-soluble resin (B) is preferably within a range from 0.1% to 40% by weight relative to 100% by weight of the solid fraction of the polyacrylamide resin (A). This amount is more preferably from 1% to 38%. A composition containing 1% to 30% of the solid fraction of the water-soluble resin (B) relative to 100% by weight of the solid fraction of the polyacrylamide resin (A) may be used as the aqueous ink composition of the present invention. Ensuring that the amount of the solid fraction of the water-soluble resin (B) is within a range from 0.1% to 40% can improve the “dry rubbing resistance” and the “wet rubbing resistance” described above.

The double bond-containing monomer used in forming the water-soluble resin (B) may be selected appropriately from any of the monomers that yield resins which satisfy the solid fraction acid value and glass transition temperature ranges described above. Examples of the double bond-containing monomer include, but not limited to, acidic monomers, other acrylic monomers and styrene-based monomers. Among the various possible double bond-containing monomers, acidic monomers and styrene-based monomers are preferred. The weight-average molecular weight of the water-soluble resin (B) is preferably within a range from 5,000 to 500,000, and is more preferably from 7,000 to 30,000.

An acidic monomer is essential in forming the water-soluble resin (B), and specific examples of this acidic monomer include, but not limited to, (meth)acrylic acid, phthalic acid monohydroxyethyl acrylate, p-carboxybenzyl acrylate, ethylene oxide-modified (number of added moles: 2 to 18) phthalic acid acrylate, phthalic acid monohydroxypropyl acrylate, succinic acid monohydroxyethyl acrylate, β-carboxyethyl acrylate, 2-(4-benzoyl-3-hydroxyphenoxy)ethyl acrylate, maleic acid, maleic anhydride, monoethylmaleic acid, itaconic acid, citraconic acid and fumaric acid. Among these, (meth)acrylic acid, maleic acid and maleic anhydride are preferred.

(Acrylic Resin (b1))

The acrylic resin (b1) mentioned above is preferably a copolymer of the acidic monomer described above and an acrylic monomer, and examples of the acrylic monomer include, but not limited to, methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, isooctyl (meth)acrylate, decyl (meth)acrylate, dodecyl (meth)acrylate, tetradecyl (meth)acrylate, hexadecyl (meth)acrylate and octadecyl (meth)acrylate. These acrylic monomers may be used individually, or combinations of two or more monomers may be used.

The acrylic monomer may have a hydroxyl group, and examples of such monomers include, but not limited to, hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 6-hydroxyhexyl (meth)acrylate and 8-hydroxyoctyl (meth)acrylate, glycol mono(meth)acrylates such as polyethylene glycol mono(meth)acrylate, polypropylene glycol mono(meth)acrylate and 1,4-cyclohexanedimethanol mono(meth)acrylate, as well as caprolactone-modified (meth)acrylates and hydroxyethylacrylamide. Among these monomers, 2-hydroxyethyl (meth)acrylate and 4-hydroxybutyl (meth)acrylate are particularly preferred, as they improve the solubility in water. These monomers may be used individually, or combinations of two or more monomers may be used.

The acrylic monomer may have a functional group other than a hydroxyl group, and examples of this functional group include an amide linking group, amino group, alkylene oxide group, and a benzene ring structure.

Examples of amide linking group-containing acrylic monomers, which are aforementioned acrylic monomers having an amide linking group, include, but not limited to, compounds such as N-methylacrylamide, N-isopropylacrylamide, N,N-dimethylacrylamide, N,N-diethylacrylamide, N,N-dimethylaminopropyl (meth)acrylamide, diacetoneacrylamide, N-(hydroxymethyl)acrylamide and N-(butoxymethyl)acrylamide.

Further, examples of amino group-containing acrylic monomers, which are aforementioned acrylic monomers having an amino group, include, but not limited to, monoalkylaminoalkyl esters of (meth)acrylic acid such as monomethylaminoethyl (meth)acrylate, monoethylaminoethyl (meth)acrylate, monomethylaminopropyl (meth)acrylate and monoethylaminopropyl (meth)acrylate.

Further, examples of alkylene oxide group-containing acrylic monomers, which are aforementioned acrylic monomers having an alkylene oxide unit, include, but not limited to, 2-methoxyethyl acrylate, 2-ethoxyethyl acrylate, 2-phenoxyethyl acrylate, methoxy polyethylene glycol (meth)acrylate, ethoxy polyethylene glycol (meth)acrylate, methoxy polypropylene glycol (meth)acrylate, ethoxy polypropylene glycol (meth)acrylate, phenoxy polyethylene glycol (meth)acrylate and phenoxy polypropylene glycol (meth)acrylate.

Examples of benzene ring structure-containing acrylic monomers, which are aforementioned acrylic monomers having a benzene ring structure, include, but not limited to, phenyl (meth)acrylate, benzyl (meth)acrylate, phenoxymethyl (meth)acrylate, phenoxyethyl (meth)acrylate and 2-hydroxy-3-phenoxypropyl (meth)acrylate.

(Styrene-Acidic Monomer Copolymer Resin (b2))

The styrene-acidic monomer copolymer resin (b2) is preferably a copolymer of a styrene-based monomer and an acidic monomer described above, and examples of the styrene-based monomer include, but not limited to, styrene, a-methylstyrene, p-methylstyrene and dimethylstyrene. Among the various possibilities, styrene is preferred as the styrene-based monomer. The styrene structure imparts an appropriate level of hydrophobicity to the ink film, and can dramatically improve the aforementioned “dry rubbing resistance” and “wet rubbing resistance” without impairing the permeability in the impregnation step. Preferred examples of the acidic monomer include, but not limited to, (meth)acrylic acid, maleic acid and maleic anhydride. The styrene-acidic monomer copolymer resin (b2) may also be further copolymerized with another double bond-containing monomer (such as an aforementioned acrylic monomer).

The styrene-acidic monomer copolymer resin (b2) is preferably a styrene-acrylic acid copolymer resin or a styrene-maleic acid copolymer resin. The weight-average molecular weight of the styrene-acidic monomer copolymer resin (b2) is preferably within a range from 10,000 to 200,000.

The (meth)acrylic acid, maleic acid, or maleic anhydride or the like in the styrene-acidic monomer copolymer resin (b2) may be partially esterified with an alcohol. Examples of preferred alcohols in those cases where this type of esterification is performed include, but not limited to, methanol, ethanol, propanol, butanol, isobutanol, hexanol and other higher alcohols having a carbon number of 10 or higher, wherein any of these alcohols may have a branched structure.

Further, as mentioned above, it is preferable that some or all of the carboxyl groups contained in the styrene-acidic monomer copolymer resin (b2) are neutralized with the amine compound (c) described above. The amine compound (c) is preferably water-soluble and easily volatilized by heating, and ammonia is particularly desirable. The pH of the styrene-acidic monomer copolymer resin (b2) is preferably from 7 to 9.

In those cases where the styrene-acidic monomer copolymer resin (b2) is either a styrene-acrylic acid copolymer resin or a styrene-maleic acid copolymer resin, the copolymerization ratio (weight % ratio) between the styrene and the acrylic acid or maleic acid is preferably within a range from 40:60 to 80:20.

### <Emulsion Resin (C)>

The aqueous ink composition of the present invention preferably also comprises an emulsion resin (C) having a minimum film-forming temperature (MFT) of 40° C. or lower.

The emulsion resin (C) contains a resin dispersed in particulate form, and also including the emulsion resin (C) in the aqueous ink composition of the present invention can dramatically improve the “wet rubbing resistance.” Further, by also including the aforementioned water-soluble resin (B) in combination with the emulsion resin (C), both the “dry rubbing resistance” and the “wet rubbing resistance” can be further improved. The amount used of the emulsion resin (C) is preferably within a range from 0.1% to 40% by weight of the solid fraction of the emulsion resin (C) relative to 100% by weight of the solid fraction of the polyacrylamide resin (A). An amount from 1% to 38% is more preferred. The emulsion resin (C) may be used in a solid fraction amount of 1% to 30% relative to 100% by weight of the solid fraction of the polyacrylamide resin (A).

In order to facilitate film formation from the emulsion, the emulsion resin (C) preferably has an MFT of 40° C. or lower, and this MFT value may be 38° C. or lower, 35° C. or lower, 30° C. or lower, 25° C. or lower, 20° C. or lower, 15° C. or lower, or 10° C. or lower or the like. Furthermore, the glass transition temperature of the emulsion resin (C) is preferably within a range from −10° C. to 60° C., more preferably from 15° C. to 60° C. A resin having a glass transition temperature of 0° C. to 50° C. may also be used. The weight-average molecular weight of the emulsion resin (C) is preferably within a range from 100,000 to 500,000.

The average particle size of the emulsion resin (C) is preferably 0.2 μm or less. Provided the average particle size is 0.2 μm or less, the stability over time of the aqueous ink composition of the present invention is also favorable. In this description, the average particle size means the particle size at a cumulative value of 50% (D50) in a particle size distribution obtained using the Coulter counter method, or the particle size at a cumulative value of 50% (D50) in a particle size distribution obtained using a laser diffraction and scattering method.

Furthermore, the emulsion resin (C) is preferably at least one resin selected from the group consisting of acrylic resins (c1), styrene-acrylic copolymer resins (c2), and urethane resins (c3).

(Acrylic Resin (c1))

The acrylic resin (c1) may be designed by appropriate combination of the acrylic monomers and acidic monomers and the like described above, provided the minimum film-forming temperature (MFT) of the resin is 40° C. or lower.

(Styrene-Acrylic Copolymer Resin (c2))

An aqueous emulsion of the styrene-acrylic copolymer resin (c2) may be prepared by copolymerizing an aforementioned styrene monomer and an aforementioned acrylic monomer, and may also include an aforementioned acidic monomer. The styrene-acrylic copolymer resin (c2) is preferably a styrene-acrylic acid copolymer resin (c2), in which the carboxyl groups may be esterified with an alcohol. In such a case, the acid value is preferably from 10 to 200 mgKOH/g, and the styrene:acrylic acid copolymerization ratio (weight % ratio) may be adjusted as appropriate so as to achieve this acid value. Further, some or all of the carboxyl groups contained in the copolymer resin may be neutralized with the amine compound (c) described above. The amine compound (c) is preferably water-soluble and easily volatilized by heating, and ammonia is particularly desirable.

(Urethane Resin (c3))

The urethane resin (c3) is preferably prepared by reacting a polyol and a polyisocyanate to obtain an isocyanate-terminated urethane prepolymer, and then performing chain extension with a polyamine if required.

There are no particular limitations on the polyol, and examples include, but not limited to, known polyether polyols, polyester polyols, polycaprolactone polyols and polycarbonate polyols, which may also be combined with other dimer diols, hydrogenated dimer diols, or castor oil-modified polyols or the like. The polyol is preferably a polyester polyol or a polycarbonate polyol. Further, a low-molecular weight polyfunctional alcohol can also be used as the polyol. Examples of such polyfunctional alcohols include, but not limited to, butanediol, trimethylolpropane, glycerol, pentaerythritol and dipentaerythritol. The polyfunctional alcohol is preferably trimethylolpropane.

Any of the various known aliphatic or alicyclic diisocyanates can be used as the aforementioned polyisocyanate. Representative examples of diisocyanates that can be used in the present invention include, but not limited to, butane-1,4-diisocyanate, hexamethylene diisocyanate, isopropylene diisocyanate, methylene diisocyanate, 2,2,4-trimethylhexamethylene diisocyanate, 2,4,4-trimethylhexamethylene diisocyanate, cyclohexane-1,4-diisocyanate, xylylene diisocyanate, isophorone diisocyanate, lysine diisocyanate, dicyclohexylmethane-4,4′-diisocyanate, 1,3-bis(isocyanatomethyl)cyclohexane, methylcyclohexane diisocyanate, m-tetramethylcyclohexane diisocyanate, and dimer diisocyanates in which the carboxyl groups of a dimer acid have been converted to isocyanate groups. These compounds may be used individually, or combinations of two or more compounds may be used. Further, the diisocyanate may form a trimer to generate an isocyanurate ring. In terms of reactivity and the like, the diisocyanate used in the present invention is preferably isophorone diisocyanate.

Examples of the aforementioned polyamine include, but not limited to, any of the various known polyamines such as ethylenediamine, propylenediamine, hexamethylenediamine, isophoronediamine, dicyclohexylmethane-4,4′-diamine, dimer diamines in which the carboxyl groups of a dimer acid have been converted to amino groups, 2-hydroxyethylethylenediamine, 2-hydroxyethylpropylenediamine, di-2-hydroxyethylethylenediamine, di-2-hydroxyethylpropylenediamine, 2-hydroxypropylethylenediamine, di-2-hydroxypropylethylenediamine and iminobispropylamine. These compounds may be used individually, or combinations of two or more compounds may be used.

The emulsion resin (C) can be obtained by appropriate selection of the radical polymerizable monomers described above, and subsequent reaction of these monomers by emulsion polymerization in the presence of an anionic surfactant, a nonionic surfactant, or a compound having a polymer surfactant effect such as an alkali-soluble water-soluble resin having a dispersion and protection effect on the polymer particles. When used in the aqueous ink of the present invention, from the viewpoints of pigment dispersibility, fluidity and re-solubility, an aqueous emulsion resin prepared using an alkali-soluble water-soluble resin during the emulsion polymerization is preferred. The pH of the emulsion resin (C) is preferably from 7 to 9.

Examples of polymerization initiators that may be used in the emulsion polymerization include the polymerization initiators mentioned above, as well as persulfates such as ammonium persulfate and organic peroxides such as t-butyl peroxide. The amount used of the polymerization initiator is typically from 0.1 to 5 parts by weight per 100 parts by weight of the total weight of the monomer components, and may be adjusted as appropriate.

In the present invention, although there are no particular limitations on the total amount of the polyacrylamide resin (A), in terms of obtaining the effects of the present invention, the amount of the polyacrylamide resin (A) is preferably from 15 to 75% by weight, more preferably from 20 to 70% by weight, and even more preferably from 20 to 60% by weight, of 100% by weight of the solid fraction within the ink. Further, in those cases where the water-soluble resin (B) and/or the emulsion resin (C) are also used, the total amount of all the resins used preferably represents 15 to 75% by weight, and more preferably from 20 to 70% by weight, of 100% by weight of the solid fraction within the ink.

### <Pigment>

The aqueous ink composition of the present invention comprises a pigment. The types of organic pigments and inorganic pigments used in typical inks, coating materials, and recording agents and the like can be used as the pigment. Examples of organic pigments include, but not limited to, azo-based pigments, phthalocyanine-based pigments, anthraquinone-based pigments, perylene-based pigments, perinone-based pigments, quinacridone-based pigments, thioindigo-based pigments, dioxazine-based pigments, isoindolinone-based pigments, quinophthalone-based pigments, azomethine azo-based pigments, diketopyrrolopyrrole-based pigments and isoindoline-based pigments. Further, although not limited to the following organic pigments, specific examples include carmine 6B, lake red C, permanent red 2B, disazo yellow, pyrazolone orange, carmine FB, cromophtal yellow, cromophtal red, phthalocyanine blue, phthalocyanine green, dioxazine violet, quinacridone magenta, quinacridone red, indanthrone blue, pyrimidine yellow, thioindigo bordeaux, thioindigo magenta, perylene red, perinone orange, isoindolinone yellow, aniline black, diketopyrrolopyrrole red, and daylight fluorescent pigment.

Examples of white inorganic pigments that may be used as the pigment in the aqueous ink composition of the present invention include, but not limited to, titanium oxide, zinc oxide, zinc sulfide, barium sulfate, calcium carbonate, chromium oxide and silica. The use of titanium oxide as the pigment in a white ink is preferred in terms of the tinting strength, opacity, chemical resistance and weather resistance. From the viewpoint of printing performance, the titanium oxide is preferably subjected to a treatment with silica and/or alumina.

Examples of other inorganic pigments besides the white pigments mentioned above include, but not limited to, carbon black, aluminum powder, mica, bronze powder, chrome vermillion, chrome yellow, cadmium yellow, cadmium red, ultramarine blue, Prussian blue, red iron oxide, yellow iron oxide, and iron black. Aluminum may be used as a powder or a paste, but in terms of the handling properties and safety, is preferably used in the form of a paste, and either leafing or non-leafing paste may be selected as appropriate depending on the levels of luminance and density required.

The pigment is preferably used in an amount that ensures satisfactory concentration and tinting strength for the aqueous ink composition, and is preferably included in an amount of 1 to 50% by weight relative to the total weight of the ink composition. The above pigments may be used individually, or combinations of two or more pigments may be used.

If required, the hue of the aqueous ink composition of the present invention may be used in a mixture with an ink composition of another color hue (such as the process base colors totaling 5 colors including white, as well as yellow, red, cyan and black, a further three colors outside the process gamut including red (orange), green and violet, as well as transparent yellow, peony, vermilion, brown and pearl).

### <Other Resins>

The aqueous ink composition in the present invention may also comprise other aqueous polymer materials, such as aqueous resins other than the polyacrylamide resin (A) and the water-soluble resin (B). Examples of these other aqueous resins include, but not limited to, aqueous polyurethane resins, aqueous vinyl chloride-vinyl acetate copolymer resins, aqueous chlorinated polypropylene resins, aqueous ethylene-vinyl acetate copolymer resins, aqueous vinyl acetate resins, aqueous polyamide resins, aqueous cellulose resins, aqueous polyester resins, aqueous alkyd resins, aqueous polyvinyl chloride resins, aqueous rosin-based resins, aqueous rosin-modified maleic acid resins, aqueous terpene resins, aqueous phenol-modified terpene resins, aqueous ketone resins, aqueous cyclized rubbers, aqueous chlorinated rubbers, aqueous butyral resins, aqueous petroleum resins, and modified resins of these resins. These resins may be used individually, or mixtures of two or more resins may be used. The amount used of these types of aqueous resins is preferably within a range from 3 to 25% by weight relative to the total weight of the aqueous ink composition. Among these types of aqueous resins, aqueous cellulose resins are preferred.

Examples of these aqueous cellulose resins include, but not limited to, hydroxyalkyl celluloses and carboxyalkyl celluloses, wherein examples of the alkyl group include, but not limited to, a methyl group, ethyl group, propyl group, isopropyl group, butyl group, isobutyl group, pentyl group, hexyl group, and alkyl groups having a substituent. Among the various possibilities, hydroxyalkyl celluloses are preferred as the aqueous cellulose resin. The molecular weight of the aqueous cellulose resin is preferably a weight-average molecular weight within a range from 5,000 to 1,000,000, and more preferably from 10,000 to 100,000. Further, the glass transition temperature of the aqueous cellulose resin is preferably within a range from 80° C. to 200° C.

### <Additives>

The aqueous ink composition of the present invention may also comprise suitable amounts of known additives. Conventional additives such as pigment derivatives, pigment dispersants, wetting agents, adhesion assistants, leveling agents, antifoaming agents, antistatic agents, trapping agents, anti-blocking agents, wax components, and silica particles and the like may be used as necessary during production of the ink composition.

Other known crosslinking agents may also be added to the aqueous ink composition of the present invention. This enables a cured film having superior film strength and excellent chemical resistance to be formed. For example, polyaziridine compounds, polyepoxy compounds, polycarbodiimide compounds, metal chelate compounds, polyoxazoline compounds, polyisocyanates, blocked polyisocyanates, and partially or completely etherified amino resins and the like can be used as crosslinking agents. The crosslinking reaction may proceed at room temperature, or heating or the addition of a known catalyst may be used to accelerate the crosslinking reaction. Further, combinations of two or more crosslinking agents may also be used. On the other hand, poycarbonyl compounds and polyaldehyde compounds which exhibit reactivity with hydrazine compounds may also be used as required.

### <Medium>

The medium used in the aqueous ink composition of the present invention is composed mainly of water, but an organic solvent may also be used as a secondary medium for purposes such as improving the printability or the printing effects. The organic solvent is preferably a solvent that is miscible with water, and examples of organic solvents that may be used include, but not limited to, ketone-based solvents such as methyl ethyl ketone and methyl isobutyl ketone, and alcohol-based solvents such as methanol, ethanol, n-propanol, isopropanol, n-butanol, polypropylene glycol monoethyl ether and polypropylene glycol monomethyl ether. When such an organic solvent is used, the amount of the organic solvent is preferably within a range from 0.1% to 30% of 100% by weight of the entire aqueous ink composition.

### <Method for Producing Ink>

The aqueous ink composition of the present invention can be produced by dissolving and/or dispersing the polyacrylamide resin (A), and where necessary the water-soluble resin (B), and the pigment and the like, in water. The particle size distribution of the pigment dispersion can be adjusted by appropriate adjustment of factors such as the size of the grinding media in the dispersion device, the fill ratio of the grinding media, the dispersion treatment time, the discharge rate for the pigment dispersion, and the viscosity of the pigment dispersion. Typical dispersion devices such as a roller mill, ball mill, pebble mill, attritor or sand mill may be used.

Although stable dispersion of the pigment in the water can be achieved using only the aforementioned resin, a dispersant may also be added to enable even more stable dispersion of the pigment. Anionic, nonionic, cationic and amphoteric surfactants and the like can be used as the dispersant. From the viewpoint of the storage stability of the ink, a dispersant is preferably added in an amount within a range from 0.1 to 5% by weight relative to the total weight of the ink.

The incorporation of air bubbles or unexpectedly coarse particles in the ink tends to cause a deterioration in the quality of the printed items, and therefore these air bubbles and coarse particles are preferably removed by filtration or the like. Conventional devices may be used for the filtration equipment.

From the viewpoint of preventing settling of the pigment and ensuring appropriate dispersion, the viscosity of the ink composition produced by the method described above is preferably equivalent to a time of about 10 to 30 seconds for a Zahn cup #4, and from the viewpoint of the operating efficiency during ink production and printing, this time is more preferably within a range from 12 to 22 seconds.

The viscosity of the aqueous ink composition can be adjusted by appropriate selection of the types and amounts of the raw materials used, such as the amounts of resin, pigment and water used. Further, the ink viscosity can also be adjusted by altering the particle size and particle size distribution of the pigment in the ink.

### <Printing Method>

The aqueous ink composition of the present invention can be used in known printing methods such as gravure printing and flexographic printing. For example, the composition may be diluted with water or a mixture of water and an organic solvent to a viscosity and concentration appropriate for gravure printing, and then supplied to each of the printing units, either alone or in a mixture with one or more other compositions.

The printed item of the present invention can be obtained by applying the aqueous ink composition of the present invention to a decorative base paper using the printing method described above, and then performing drying in an oven to fix the ink film.

### <Decorative Base Paper>

There are no particular limitations on the decorative base paper, and any paper that can be impregnated and exhibits good water absorption can be used, including thin papers, titanium papers, wood-free papers and craft papers. Among these, titanium paper is the most desirable due to its combination of superior printability and resin impregnability. Although there are no particular limitations on the thickness of the paper, paper having a weight within a range from about 20 to 100 g/m² is generally used. Titanium paper is a specialty paper in which titanium oxide is incorporated in the paper to impart opacity, and is used as the paper substrate for decorative sheets. The titanium paper may also contain colored inorganic pigments or organic pigments in addition to the titanium oxide. These titanium papers impart a covering or coating function to the phenol core, plywood, particle board or hardboard or the like to which they are bonded following impregnation, and are available as printable papers or plain papers.

### <Impregnation>

The printed item of the present invention is immersed in an aqueous solution of a thermosetting compound, and following uniform permeation of the solution into the printed item, the item is dried. Examples of the thermosetting compound include, but not limited to, melamine-based resins, epoxy-based resins, urea-based resins, phenol-based resins, unsaturated polyester-based resins, diallyl phthalate-based resins, benzoguanamine-based resins, urethane-based resins, aminoalkyd-based resins, acrylic-based resins and silicone-based resins, and although a compound selected from among melamine resins, polyester resins and diallyl phthalate resins is preferred, the thermosetting compound is not limited to such compounds.

The solid fraction concentration of the aqueous solution of the thermosetting compound is preferably from 40% to 60%, and the immersion time is preferably from 1 to 15 minutes. The drying conditions preferably involve drying at 80° C. to 100° C. for a period of 2 to 5 minutes.

### <Laminate for Decorative Sheet>

Using the printed item described above, a laminate for a decorative sheet comprising a substrate and a surface layer can be obtained. The surface layer is formed from the thermosetting compound and the printed item.

Specifically, the printed item prepared by printing the aqueous ink composition of the present invention and then impregnating and drying the printed item is bonded to a decorative sheet that functions as the substrate by thermocompression bonding, thereby curing the thermosetting compound incorporated within the base paper. Examples of materials that may be used as the decorative sheet include wood-based substrates such as simple wooden sheets, plywood sheets, laminated timber, particle board, medium-density fiberboard and hard fiberboard, fibrous substrates such as cardboard, woven fabric, nonwoven fabric, resin-impregnated paper and resin-impregnated fabric, inorganic material substrates such as gypsum plasterboard, slate board, calcium silicate board, slag gypsum board, wood wool cement board, slag cement board, lightweight cellular concrete panels and glass fiber-reinforced concrete panels, metal-based substrates such as steel sheets, brass plate, aluminum sheets, duralumin plate and stainless steel sheets, synthetic resin substrates such as acrylic resin sheets, polystyrene resin sheets, ABS resin sheets, polycarbonate resin sheets, nylon resin sheets, polyolefin resin sheets, polyester resin sheets and glass fiber-reinforced plastic sheets, as well as mixtures, composites or laminates or the like comprising two or more of these materials.

As described above, one embodiment of the present invention is an aqueous ink composition for use on a base paper for a decorative sheet, the aqueous ink composition comprising a pigment and a water-soluble polyacrylamide resin (A).

One embodiment of the present invention may be an aqueous ink composition in which the proportion of structural units derived from acrylamide within 100% by weight of the polyacrylamide resin (A) is 70% by weight or greater.

One embodiment of the present invention may be an aqueous ink composition in which the glass transition temperature of the polyacrylamide resin (A) is within a range from 80° C. to 200° C.

One embodiment of the present invention may be an aqueous ink composition which further comprises a water-soluble resin (B) having a solid fraction acid value prior to neutralization of 50 to 350 mgKOH/g and a glass transition temperature within a range from 50° C. to 140° C. (but different resin from the polyacrylamide resin (A)).

One embodiment of the present invention may be an aqueous ink composition which further comprises an emulsion resin (C) having a minimum film-forming temperature (MFT) of 40° C. or lower.

One embodiment of the present invention may be an aqueous ink composition in which the aforementioned water-soluble resin (B) is at least one resin selected from the group consisting of acrylic resins (b1) and styrene-acidic monomer copolymer resins (b2).

One embodiment of the present invention may be an aqueous ink composition in which the aforementioned emulsion resin (C) is at least one resin selected from the group consisting of acrylic resins (c1), styrene-acrylic copolymer resins (c2), and urethane resins (c3).

One embodiment of the present invention may be an aqueous ink composition in which the amount of the water-soluble resin (B) is within a range from 0.1% by weight to 40% by weight relative to 100% by weight of the polyacrylamide resin (A).

One embodiment of the present invention may be an aqueous ink composition in which the amount of the emulsion resin (C) is within a range from 0.1% by weight to 40% by weight relative to 100% by weight of the polyacrylamide resin (A).

One aspect of the present invention provides a printed item having a printed layer formed from the aqueous ink composition described above formed on a base paper for a decorative sheet.

One aspect of the present invention provides a laminate for a decorative sheet comprising a substrate and a surface layer, wherein the surface layer is formed from a thermosetting compound and the printed item described above.

### EXAMPLES

The present invention is described below in further detail using a series of examples, but the present invention is in no way limited by these examples. Unless specifically noted otherwise, “parts” and “%” represent “parts by weight” and “% by weight” respectively.

Weight-average molecular weight values in the following examples were obtained by performing measurements under the conditions described below.

GPC main unit: LC1100 series, manufactured by Agilent Technologies, Inc.

Column: Shodex SB806MHQ, manufactured by Showa Denko K.K.

Eluent: N/15 phosphate buffer containing N/10 sodium nitrate (pH 3)

Flow rate: 1.0 ml/minute

Detector 1: Multi-angle light scattering detector DAWN, manufactured by Wyatt Technology Corporation

Detector 2: Differential refractive index detector RI-101, manufactured by Showa Denko K.K.

As described above, the glass transition temperature was determined using the FOX equation.

As mentioned above, the acid value was measured in accordance with JIS K0070.

### Synthesis Example 1

In a 1-liter four-necked flask fitted with a stirrer, a thermometer, a reflux condenser and a nitrogen gas inlet tube, 250 parts of water, 198 parts of a 50% aqueous solution of acrylamide (hereafter abbreviated as “Am”) and 2.0 parts of dimethylacrylamide (hereafter abbreviated as “DMMA”) were mixed and stirred. Subsequently, the temperature was raised to 60° C. under a nitrogen gas atmosphere, 0.3 parts of ammonium persulfate was added as a polymerization initiator, the polymerization was initiated, and the reaction temperature was raised to 90° C. An additional 0.3 parts of ammonium persulfate was then added, and when the viscosity at 25° C. reached 3,000 mPa·s, 51 parts of water was added to obtain a polyacrylamide-based resin P1 having a solid fraction of 20%. The weight-average molecular weight was 3,000,000 and the Tg was 164.5° C.

### Synthesis Examples 2 to 5

Using the raw materials and blend ratios shown in Table 1, polyacrylamide-based resins (P2 to P5) were obtained using the same procedure as that described in Synthesis Example 1. The abbreviations used for the raw materials are listed below.

Am: acrylamide

DMAA: dimethylacrylamide

IBXA: isobornyl acrylate

ADMA: adamantane methacrylate

BA: butyl acrylate

TABLE 1

| | | | | | | | Glass | |
|---|---|---|---|---|---|---|---|---|
| | | | | | | | tran- | |
| | Monomer | | | | | | sition | |
| | Am | IBXA | DMAA | ADMA | BA | | tem- | Weight- |
| | Glass transition temperature of | | | | | | per- | average |
| | homopolymer (° C.) | | | | | | ature | molecular |
| | 165 | 94 | 119 | 250 | −55 | Total | (° C.) | weight |
| P1 | 99 | | 1 | | | 100 | 164.5 | 3,000,000 |
| P2 | 100 | | | | | 100 | 165.0 | 3,500,000 |
| P3 | 90 | 10 | | | | 100 | 156.7 | 2,800,000 |
| P4 | 85 | | | | 15 | 100 | 107.4 | 5,000,000 |
| P5 | 75 | 5 | | 20 | | 100 | 175.2 | 3,000,000 |

### Example 1

First, 35 parts of the polyacrylamide-based resin P1 obtained in the above Synthesis Example 1, 12 parts of C.I. Pigment Red 185 as a pigment, and 53 parts of water were mixed for 60 minutes using a Disper. The resulting mixed liquid was then dispersed for 30 minutes using a sand mill (media: glass beads of diameter 1.2 mm), yielding an aqueous ink composition S1.

### Examples 2 to 18

Using the raw materials shown in Table 2-1, aqueous ink compositions S2 to S18 were obtained using the same procedure as that described for Example 1.

The abbreviations used for the raw materials shown in Table 2-1 are listed below.
Joncryl HPD-96J: manufactured by BASF Corporation, a styrene-acrylic acid-based resin aqueous solution neutralized with alkaline water, NV 34% aqueous solution, weight-average molecular weight: 17,000, Tg: 102° C., solid fraction acid value: 240 mgKOH/g, pH: 8.5
Joncryl JDX-6180: manufactured by BASF Corporation, a styrene-acrylic acid-based resin aqueous solution neutralized with alkaline water, NV 27% aqueous solution, weight-average molecular weight: 14,000, Tg: 134° C., solid fraction acid value: 230 mgKOH/g, pH: 8.5
Joncryl JDX-6500: manufactured by BASF Corporation, an acrylic-based resin aqueous solution neutralized with alkaline water, NV 29.5% aqueous solution, weight-average molecular weight: 10,000, Tg: 65° C., solid fraction acid value: 85 mgKOH/g, pH: 7.5
Joncryl 352D: a styrene-acrylic-based resin emulsion, NV 45% aqueous solution, weight-average molecular weight: 250,000, minimum film-forming temperature: 10° C., Tg: 56° C., solid fraction acid value: 51 mgKOH/g, pH: 8.3
Joncryl 775: a styrene-acrylic-based resin emulsion, NV 45% aqueous solution, weight-average molecular weight: 300,000, minimum film-forming temperature: 15° C., Tg: 37° C., solid fraction acid value: 55 mgKOH/g, pH: 8.3
EK-108: manufactured by Saiden Chemical Industry Co., Ltd., an acrylic-based resin emulsion, NV 35% aqueous solution, minimum film-forming temperature: 38° C., Tg: 56° C., pH: 8.0
Superflex 150: manufactured by DKS Co., Ltd., a urethane (using both polyether and polyester) based resin emulsion, NV 30% aqueous solution, minimum film-forming temperature: 5° C., Tg: 40° C., pH: 9.0

### Comparative Examples 1 to 10

Using the raw materials shown in Table 2-2, aqueous ink compositions T1 to T10 were obtained using the same procedure as that described for Example 1.

The abbreviations used for the raw materials shown in Table 2-2 are listed below.
Urearno W321: a polyether-based water-soluble urethane resin (NV 33%)
Plascoat Z-565: manufactured by GOO Chemical Co., Ltd., a water-soluble polyester resin (NV 25%)
Super Ester NS-121: a rosin emulsion (NV 50%)
Urearno KL-593: manufactured by Arakawa Chemical Industries, Ltd., an oil-based polyurethane resin (ether-ester-based) (NV 35%) in the form of an ethyl acetate/isopropanol (IPA) solution

TABLE 2-1

| | | | Example | | | | | | | | |
|---|---|---|---|---|---|---|---|---|---|---|---|
| | | | 1 | 2 | 3 | 4 | 5 | 6 | 7 | 8 | 9 |
| Ink name | | Resin type | S1 | S2 | S3 | S4 | S5 | S6 | S7 | S8 | S9 |
| Polyacrylamide | P1 | polyacrylamide-based | 8.0 | | | | | | | | |
| resin (A) | P2 | polyacrylamide-based | | 8.0 | | | | 7.0 | 7.0 | 7.0 | 7.0 |
| (solid fraction) | P3 | polyacrylamide-based | | | 8.0 | | | | | | |
| | P4 | polyacrylamide-based | | | | 8.0 | | | | | |
| | P5 | polyacrylamide-based | | | | | 8.0 | | | | |
| Water-soluble | Joncryl HPD-96J | styrene/acrylic acid-based | | | | | | 1.0 | | | |
| resin (B) | Joncryl JDX-6180 | styrene/acrylic acid-based | | | | | | | 1.0 | | |
| (solid fraction) | Joncryl JDX-6500 | acrylic-based | | | | | | | | 1.0 | |
| Emulsion resin | Joncryl 352D | styrene/acrylic-based | | | | | | | | | 1.0 |
| (C) | Joncryl 775 | styrene/acrylic-based | | | | | | | | | |
| (solid fraction) | EK-108 | acrylic-based | | | | | | | | | |
| | Superflex 150 | urethane-based | | | | | | | | | |
| Pigment | C.I. Pigment | — | 10.0 | 10.0 | 10.0 | 10.0 | 10.0 | 10.0 | 10.0 | 10.0 | 10.0 |
| | Red 185 | | | | | | | | | | |
| Medium | Water | — | 82.0 | 82.0 | 82.0 | 82.0 | 82.0 | 82.0 | 82.0 | 82.0 | 82.0 |
| Ink total | | — | 100.0 | 100.0 | 100.0 | 100.0 | 100.0 | 100.0 | 100.0 | 100.0 | 100.0 |
| Solid fraction total | | | 18.0 | 18.0 | 18.0 | 18.0 | 18.0 | 18.0 | 18.0 | 18.0 | 18.0 |
| Resin A solid fraction % within | | | 44.4 | 44.4 | 44.4 | 44.4 | 44.4 | 38.9 | 38.9 | 38.9 | 38.9 |
| ink solid fraction | | | | | | | | | | | |
| Resin B/Resin A solid fraction % | | — | 0.0 | 0.0 | 0.0 | 0.0 | 0.0 | 14.3 | 14.3 | 14.3 | 0.0 |
| Resin C/Resin A solid fraction % | | — | 0.0 | 0.0 | 0.0 | 0.0 | 0.0 | 0.0 | 0.0 | 0.0 | 14.3 |
| | | | Example | | | | | | | | |
| | | | 10 | 11 | 12 | 13 | 14 | 15 | 16 | 17 | 18 |
| Ink name | | Resin type | S10 | S11 | S12 | S13 | S14 | S15 | S16 | S17 | S18 |
| Polyacrylamide | P1 | polyacrylamide-based | | | | | | | | 7.0 | 7.0 |
| resin (A) | P2 | polyacrylamide-based | 7.0 | 7.0 | 7.0 | 15.0 | 4.0 | 15.0 | 4.0 | | |
| (solid fraction) | P3 | polyacrylamide-based | | | | | | | | | |
| | P4 | polyacrylamide-based | | | | | | | | | |
| | P5 | polyacrylamide-based | | | | | | | | | |
| Water-soluble | Joncryl HPD-96J | styrene/acrylic acid-based | | | | 0.2 | 1.5 | | | 1.0 | 1.0 |
| resin (B) | Joncryl JDX-6180 | styrene/acrylic acid-based | | | | | | | | | |
| (solid fraction) | Joncryl JDX-6500 | acrylic-based | | | | | | | | | |
| Emulsion resin | Joncryl 352D | styrene/acrylic-based | | | | | | | | 1.0 | |
| (C) | Joncryl 775 | styrene/acrylic-based | 1.0 | | | | | | | | 1.0 |
| (solid fraction) | EK-108 | acrylic-based | | 1.0 | | | | 0.2 | 1.5 | | 1.0 |
| | Superflex 150 | urethane-based | | | 1.0 | | | | | | |
| Pigment | C.I. Pigment | — | 10.0 | 10.0 | 10.0 | 10.0 | 10.0 | 10.0 | 10.0 | 10.0 | 10.0 |
| | Red 185 | | | | | | | | | | |
| Medium | Water | — | 82.0 | 82.0 | 82.0 | 74.8 | 84.5 | 82.0 | 84.5 | 82.0 | 81.0 |

| | | | | | | | | | | |
|---|---|---|---|---|---|---|---|---|---|---|
| Ink total | — | 100.0 | 100.0 | 100.0 | 100.0 | 100.0 | 107.2 | 100.0 | 101.0 | 101.0 |
| Solid fraction total | | 18.0 | 18.0 | 18.0 | 25.2 | 15.5 | 25.2 | 15.5 | 19.0 | 20.0 |
| Resin A solid fraction % within | | 38.9 | 38.9 | 38.9 | 59.5 | 25.8 | 59.5 | 25.8 | 36.8 | 35.0 |
| ink solid fraction | | | | | | | | | | |
| Resin B/Resin A solid fraction % | — | 0.0 | 0.0 | 0.0 | 1.3 | 37.5 | 0.0 | 0.0 | 14.3 | 14.3 |
| Resin C/Resin A solid fraction % | — | 14.3 | 14.3 | 14.3 | 0.0 | 0.0 | 1.3 | 37.5 | 14.3 | 28.6 |

TABLE 2-2

| | | | Comparative Example | | | | | | | | | |
|---|---|---|---|---|---|---|---|---|---|---|---|---|
| | | | 1 | 2 | 3 | 4 | 5 | 6 | 7 | 8 | 9 | 10 |
| | Ink name | | T1 | T2 | T3 | T4 | T5 | T6 | T7 | T8 | T9 | T10 |
| Solid | Styrene/acrylic-based | Joncryl HPD-96J | 8.0 | | | | | | | 3.5 | 3.5 | 3.5 |
| fraction % | aqueous solution | | | | | | | | | | | |
| | Acrylic-based aqueous | Joncryl JDX-6500 | | 8.0 | | | | | | 3.5 | | |
| | solution | | | | | | | | | | | |
| | Acrylic-based emulsion | EK-108 | | | 8.0 | | | | | | 3.5 | |
| | Urethane-based | Urearno W321 | | | | 8.0 | | | | | | 3.5 |
| | (water/IPA solution) | | | | | | | | | | | |
| | Polyester-based | Plascoat Z-565 | | | | | 8.0 | | | | | |
| | Rosin emulsion | Super Ester NS-121 | | | | | | 8.0 | | | | |
| | Urethane-based | Urearno KL-593 | | | | | | | 8.0 | | | |
| | (water/IPA solution) | | | | | | | | | | | |

| | | | | | | | | | | | |
|---|---|---|---|---|---|---|---|---|---|---|---|
| Pigment | C.I. Pigment Red 185 | 10 | 10 | 10 | 10 | 10 | 10 | 10 | 10 | 10 | 10 |
| Medium | Ethyl acetate/IPA = 50:50 | | | | | | | 82 | | | |
| | Water | 82 | 82 | 82 | 82 | 82 | 82 | | 83 | 83 | 83 |

| | | | | | | | | | | |
|---|---|---|---|---|---|---|---|---|---|---|
| Total | 100 | 100 | 100 | 100 | 100 | 100 | 100 | 100 | 100 | 100 |
| Solid fraction % in ink | 18 | 18 | 18 | 18 | 18 | 18 | 18 | 17 | 17 | 17 |
| Resin % within solid fraction | 44 | 44 | 44 | 44 | 44 | 44 | 44 | 41 | 41 | 41 |

### <Printing of Aqueous Ink Compositions>

### Example 19

The aqueous ink composition S1 described above was diluted with a mixed aqueous solution (water:IPA=7:3) to achieve a viscosity of 16 seconds (25° C., Zahn cup No. 3), and a gravure printer fitted with a solid image printing plate having a laser plate depth of 30 um was used to print the ink composition onto a titanium paper (60 g/m²) at a printing speed of 50 m/min, thus obtaining a printed item SS1.

### Examples 20 to 36

Using the same procedure as Example 19, the aqueous ink compositions S2 to S18 shown in Table 2-1 were used to obtain printed items SS2 to SS18 (Examples) respectively.

### Comparative Examples 11 to 20

Using the same procedure as Example 19, the aqueous ink compositions T1 to T10 shown in Table 2-2 were used to obtain printed items TT1 to TT10 (Comparative Examples) respectively. In Comparative Example 17, a mixed solvent (ethyl acetate/IPA=50:50) was used instead of the mixed aqueous solution (water:IPA=7:3) to dilute the composition to achieve a viscosity of 16 seconds (25° C., Zahn cup No. 3), and printing was then performed in the same manner as described above.

For each of the aqueous ink compositions S1 to S18 (Examples) and T1 to T10 (Comparative Examples) and each of the printed items SS1 to SS18 (Examples) and TT1 to TT10 (Comparative Examples) obtained in Examples 1 to 36 and Comparative Examples 1 to 20, tests were performed to evaluate the melamine aqueous solution impregnability, the dry rubbing resistance, the wet rubbing resistance, the laminate blistering resistance, and the ink stability. The results of these evaluations are shown in Table 3-1 and Table 3-2.

### <Thermosetting Resin Solution Impregnability>

For each of the printed items SS1 to SS18 (Examples) and TT1 to TT10 (Comparative Examples), a 10 cm×10 cm sample of the printed item was immersed for 30 seconds in 500 ml of a melamine resin solution (water-soluble methylol melamine (manufactured by Nippon Carbide Industries Co., Inc.)/water=50:50), and the surface area of the resulting impregnated portion (wet portion) was evaluated.

A: the printed portion was 100% impregnated

B: 95% or more of the printed portion was impregnated

C: at least 50% but less than 95% of the printed portion was impregnated

D: at least 30% but less than 50% of the printed portion was impregnated

E: no impregnation

Evaluations results of A or B indicate no problems from a practical perspective.

### <Dry Rubbing Resistance>

Each of the printed items SS1 to SS18 (Examples) and TT1 to TT10 (Comparative Examples) was set in a Gakushin crockmeter, and was rubbed 5 times against a wood-free paper using a loading of 300 g. The level of scratching of the retrieved printed item was then evaluated visually against the following 5-grade scale.

A: no scratches at all

B: slight scratches on less than 10% of the printed portion

C: scratches visible on at least 10% but less than 30% of the printed portion

D: scratches visible on at least 30% but less than 50% of the printed portion

E: scratches across the entire printed portion

Evaluations results of A or B indicate no problems from a practical perspective.

### <Wet Rubbing Resistance>

Each of the printed items SS1 to SS18 (Examples) and TT1 to TT10 (Comparative Examples) was set in a Gakushin crockmeter, and was rubbed 5 times against a water-containing cotton cloth using a loading of 100 g. The level of scratching of the retrieved printed item was then evaluated visually against the following 5-grade scale.

A: no scratches at all

B: slight scratches on less than 10% of the printed portion

C: scratches visible on at least 10% but less than 30% of the printed portion

D: scratches visible on at least 30% but less than 50% of the printed portion

E: scratches across the entire printed portion

Evaluations results of A or B indicate no problems from a practical perspective.

### <Laminate Blistering Resistance>

Each of the printed items SS1 to SS18 (Examples) and TT1 to TT10 (Comparative Examples) was impregnated and then dried under the conditions described above, and was then placed on a sheet of a 9.0 mm particle board “Novopan” manufactured by Japan Novopan Industrial Co., Ltd. A laminate was then prepared by thermocompression bonding using a hot press machine at 35 kg/cm² and 190° C., and the resulting laminate was evaluated for blistering (lifting of the printed item).

A: no lifting at all was observed across the printed portion

B: lifting visible across less than 10% of the printed portion

C: lifting visible across at least 10% but less than 30% of the printed portion

D: lifting visible across at least 30% but less than 50% of the printed portion

E: bonding did not occur

Evaluations results of A or B indicate no problems from a practical perspective.

### <Ink Stability>

Each of the aqueous ink compositions S1 to S18 (Examples) and T1 to T10 (Comparative Examples) and each of the printed items SS1 to SS18 (Examples) and TT1 to TT10 (Comparative Examples) was stored for one week in an oven at 50° C., and the stability over time was evaluated. Measurements were performed using a Zahn cup #4 manufactured by Rigo Co., Ltd., at a liquid temperature of 25° C., and the change in viscosity was evaluated.

A: no change in viscosity observed over time

B: increase in viscosity over time of less than 5 seconds

C: increase in viscosity over time of at least 5 seconds but less than 20 seconds

D: increase in viscosity over time of at least 20 seconds but less than 40 seconds

E: composition gelled over time

Evaluations results of A or B indicate no problems from a practical perspective.

TABLE 3-1

| | Example | | | | | | | | | | | | | | | | | |
|---|---|---|---|---|---|---|---|---|---|---|---|---|---|---|---|---|---|---|
| | 19 | 20 | 21 | 22 | 23 | 24 | 25 | 26 | 27 | 28 | 29 | 30 | 31 | 32 | 33 | 34 | 35 | 36 |
| Ink name | S1 | S2 | S3 | S4 | S5 | S6 | S7 | S8 | S9 | S10 | S11 | S12 | S13 | S14 | S15 | S16 | S17 | S18 |
| Printed item | SS1 | SS2 | SS3 | SS4 | SS5 | SS6 | SS7 | SS8 | SS9 | SS10 | SS11 | SS12 | SS13 | SS14 | SS15 | SS16 | SS17 | SS18 |
| Melamine aqueous | A | A | A | A | A | A | A | A | A | A | A | A | A | A | A | A | A | A |
| solution | | | | | | | | | | | | | | | | | | |
| impregnability | | | | | | | | | | | | | | | | | | |
| Dry rubbing | B | B | B | B | B | A | A | A | B | B | B | B | B | A | B | A | A | A |
| resistance | | | | | | | | | | | | | | | | | | |
| Wet rubbing | B | A | B | B | B | B | B | B | A | A | A | B | B | B | B | B | A | A |
| resistance | | | | | | | | | | | | | | | | | | |
| Laminate blistering | A | A | A | A | A | A | A | A | A | A | A | A | A | A | A | A | A | A |
| resistance | | | | | | | | | | | | | | | | | | |
| Storage stability | A | A | A | A | A | A | A | A | A | A | A | A | A | A | A | A | A | A |

TABLE 3-2

| | Comparative Example | | | | | | | | | |
|---|---|---|---|---|---|---|---|---|---|---|
| | 11 | 12 | 13 | 14 | 15 | 16 | 17 | 18 | 19 | 20 |
| Ink name | T1 | T2 | T3 | T4 | T5 | T6 | T7 | T8 | T9 | T10 |
| Printed item | TT1 | TT2 | TT3 | TT4 | TT5 | TT6 | TT7 | TT8 | TT9 | TT10 |
| Melamine aqueous solution | C | C | E | C | E | C | E | C | C | C |
| impregnability | | | | | | | | | | |
| Dry rubbing resistance | C | C | C | B | E | D | A | C | C | C |
| Wet rubbing resistance | D | C | C | A | E | E | A | C | C | C |
| Laminate blistering resistance | E | E | E | D | E | C | E | E | E | E |
| Storage stability | A | A | A | A | E | A | E | A | A | A |

Based on the evaluation results, it was evident that the aqueous ink compositions of the present invention, which as a characteristic feature contained the polyacrylamide resin (A) as a water-soluble binder resin, exhibited good printability with no abrasion between the printed portion and the guide rollers (good dry rubbing resistance), good permeability following immersion (impregnation) of an adhesive during post-processing, no ink removal during that process (good wet rubbing resistance), and favorable adhesion following thermocompression bonding with a substrate during post-processing.

1. An aqueous ink composition for use on a base paper for a decorative sheet, the aqueous ink composition comprising:
a pigment, and
a water-soluble polyacrylamide resin (A).

2. The aqueous ink composition according to claim 1, wherein
a proportion of structural units derived from acrylamide within 100% by weight of the polyacrylamide resin (A) is 70% by weight or greater.

3. The aqueous ink composition according to claim 1, wherein
a glass transition temperature of the polyacrylamide resin (A) is within a range from 80° C. to 200° C.

4. The aqueous ink composition according to claim 1, further comprising:
a water-soluble resin (B), wherein
the water-soluble resin (B) has a solid fraction acid value prior to neutralization of 50 to 350 mgKOH/g and a glass transition temperature within a range from 50° C. to 140° C., and is a different resin from the polyacrylamide resin (A).

5. The aqueous ink composition according to claim 1, further comprising:
an emulsion resin (C), wherein
the emulsion resin (C) has a minimum film-forming temperature (MFT) of 40° C. or lower.

6. The aqueous ink composition according to claim 1, further comprising:
a water-soluble resin (B) and an emulsion resin (C), wherein
the water-soluble resin (B) has a solid fraction acid value prior to neutralization of 50 to 350 mgKOH/g and a glass transition temperature within a range from 50° C. to 140° C., and is a different resin from the polyacrylamide resin (A), and
the emulsion resin (C) has a minimum film-forming temperature (MFT) of 40° C. or lower.

7. The aqueous ink composition according to claim 4, wherein
the water-soluble resin (B) is at least one resin selected from the group consisting of acrylic resins (b1) and styrene-acidic monomer copolymer resins (b2).

8. The aqueous ink composition according to claim 5, wherein
the emulsion resin (C) is at least one resin selected from the group consisting of acrylic resins (c1), styrene-acrylic copolymer resins (c2), and urethane resins (c3).

9. The aqueous ink composition according to claim 4, wherein
an amount of the water-soluble resin (B) is within a range from 0.1% by weight to 40% by weight relative to 100% by weight of the polyacrylamide resin (A).

10. The aqueous ink composition according to claim 5, wherein
an amount of the emulsion resin (C) is within a range from 0.1% by weight to 40% by weight relative to 100% by weight of the polyacrylamide resin (A).

11. A printed item comprising:
a base paper for a decorative sheet, and
a printed layer formed on the base paper for a decorative sheet, wherein the printed layer is formed from the aqueous ink composition according to claim 1.

12. A laminate for a decorative sheet comprising:
a substrate and a surface layer, wherein
the surface layer is formed from a thermosetting compound and the printed item according to claim 11.
